(19) United States
(12) Patent Application Publication
(10) Pub. No.: US 2008/0137896 A1
(43) Pub. Date: Jun. 12, 2008

(54) Headset Capable of Switching Signal Transmissions

(76) Inventor: Kuo-Ting Tsen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/747,243

(22) Filed: May 11, 2007

(30) Foreign Application Priority Data
Dec. 11, 2006 (TW) 095146266

(51) Int. Cl. H04R 25/00

(52) U.S. Cl. 381/370

(57) ABSTRACT

A headset device capable of switching signal transmissions includes a headset plug and a switch unit. The headset plug includes a plurality of signal interfaces for transmitting a plurality of signals. The switch unit is coupled to the headset plug and is used for modifying an order in which the plurality of signal interfaces transmits the plurality of signals according to a control signal.

### BACKGROUND OF THE INVENTION

1. Field of the Invention

The present invention relates to a headset device, and more particularly, to a headset device capable of switching signal transmissions.

2. Description of the Prior Art

A headphone is an indispensable accessory for portable electronic products. The architecture of the headphone generally includes a headset plug for receiving electronic signals, and speakers for transforming the received electronic signals into audio wave signals. Based on listening mode, the headphone can be classified into mono and stereo. A mono headphone has only one speaker suitable for voice communication. A stereo headphone has two speakers, one for transmitting a left-channel signal and the other for transmitting a right-channel signal, making the stereo headphone suitable for media-oriented applications. In recent years, with a rapid growth of mobile phone use, integration of the headphone with a microphone, or a headset, is widely adopted in the mobile phones. Through the headset, a user can enjoy hands-free operation of the mobile phone for safety and convenience. Headset plugs of the headset can be divided into two different types: three-segment plugs and four-segment plugs, both of which have the same plug size. The three-segment plug is adapted to mono voice communication, whereas the four-segment plug is suitable for use in stereo. Each segment of the headset plug is defined as a signal interface, and can exchange electronic signals with an electronic product, such as a mobile phone, an MP3 player, or a PDA, by coupling with a headset jack on the electronic product.

Please refer to FIG. 1, which is a schematic diagram of signals and connections of a three-segment headset plug 30, a four-segment headset plug 40, and a four-segment headset jack 50 according to the prior art. The three-segment headset plug 30 and the four-segment headset plug 40 are the same size, and both can be plugged into the four-segment headset jack 50. The three-segment headset plug 30 includes signal interfaces S3_1 to S3_3 used for transmitting a microphone signal MIC, a single audio channel, and a grounding signal GND, respectively. The single audio channel is a left-channel signal LCH or a right-channel signal RCH, which is not different to a user, depending on how the user wears the headset. The signals transmitted via the signal interfaces S3_1 and S3_2 can be interchanged. The four-segment headset plug 40 includes signal interfaces S4_1 to S4_4 used for transmitting the right-channel signal RCH, the left-channel signal LCH, the microphone signal MIC, and the grounding signal GND, respectively. The signals transmitted via the signal interfaces S4_1 to S4_3 can be interchanged. The four-segment headset jack 50 includes signal interfaces S5_1 to S5_4 coupled to an audio processing unit installed in a mobile phone, and used for outputting the left and right channel signals or receiving the microphone signal.

In order to process the audio signals correctly, all signals transmitted via the four-segment headset jack 50 correspond to the signal interfaces of the three-segment headset plug 30 or the four-segment headset plug 40. However, since signal allocation of the headset jack may not be the same in different mobile phones, a user has to choose the headset included with the mobile phone he purchased. Otherwise, if the signal allocation of the headset jack is different from that of the headset, the left-channel, right-channel, or microphone signals may not match with the audio signal sources when the user utilizes the headset to answer the phone or listen to music. For example, suppose the signal allocation of the four-segment headset jack 50 is: signal interface S5_1 to the left-channel signal LCH; signal interface S5_2 to the right-channel signal RCH; signal interface S5_3 to the microphone signal MIC; and signal interface S5_4 to the grounding signal GND. As shown in FIG. 1, the signal allocation of the four-segment headset plug 40 may be arranged as follows: signal interface S4_1 to the right-channel signal RCH; signal interface S4_2 to the left-channel signal LCH; signal interface S4_3 to the microphone signal MIC; and signal interface S4_4 to the grounding signal GND. The signal interfaces S4_1 to S4_4 can be correspondingly fitted with the signal interfaces S5_1 to S5_4 when the four-segment headset plug 40 is plugged into the four-segment headset jack 50. In this case, since signal allocation of the left-channel signal and right-channel signal is reversed, the left-channel signal LCH transmitted via the signal interface S5_1 passes through the signal interface S4_1, and then outputs left-channel audio sounds through the right speaker of the four-segment headset plug 40. As a result, the left-channel signal and right-channel signal outputted via the four-segment headset plug 40 are swapped according to the audio signal sources. Fortunately, reversing the left-channel signal and right-channel signals does not have a negative impact on the user's listening experience.

However, take another case for example. Suppose the signal allocation of the four-segment headset jack 50 is the same as mentioned above, while that of the three-segment headset plug 30 is arranged as follows: signal interface S3_1 to the microphone signal MIC; signal interface S3_2 to the left-channel signal LCH; and signal interface S3_3 to the grounding signal GND. When the three-segment headset plug 30 is plugged into the four-segment headset jack 50, the signal interfaces S3_1 and S3_2 are coupled to the signal interfaces S5_1 and S5_2. As can be seen from FIG. 1, the signal interface S3_3 is coupled with the signal interfaces S5_3 and S5_4. In this situation, when the mobile phone transmits the left-channel signal LCH via the signal interface S5_1, the left-channel signal LCH cannot successfully output left-channel audio sounds since the signal interface S3_1 is coupled to the microphone of the three-segment headset plug 30. Similarly, the signal interface S5_3 cannot receive the correct microphone signal MIC, so that the user's voice cannot be received and transmitted. As a result, the microphone of the three-segment headset plug 30 cannot function normally, preventing the user from using the hands-free functionality of the mobile phone via the three-segment headset plug 30.

Therefore, signal allocation on the signal interfaces of the headset plug must be the same as that of the headset jack, so that the headset can function normally. However, the manufacturers of the headset plugs and jacks usually have no consensus on the signal allocation of the headset plugs and jacks, resulting in inconvenience for the user, e.g. a consumer can only choose the headset attached with the mobile phone he purchased. If the consumer uses other headsets produced by different manufacturers than the manufacturer of the head jack, the microphone or speaker will probably not work. In this situation, for any user who owns multiple mobile phones, it is quite inconvenient for the user to purchase a different headset for each mobile phone.

### SUMMARY OF THE INVENTION

It is therefore an object of the present invention to provide a headset device capable of switching signal transmissions.

The present invention discloses a headset device capable of switching signal transmissions. The headset device includes a headset plug and a switch unit. The headset plug includes a plurality of signal interfaces for transmitting a plurality of signals. The switch unit is coupled to the headset plug and is used for modifying an order in which the plurality of signal interfaces transmits the plurality of signals according to a control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of signals and connections of a three-segment headset plug, a four-segment headset plug, and a four-segment headset jack according to the prior art.

FIG. 2 is a schematic diagram of a headset device capable of switching signal transmissions according to the present invention.

FIG. 3 is a schematic diagram of a four-segment headset capable of switching signal transmissions according to an embodiment of the present invention.

FIG. 4 is a signal transmission mode of the four-segment headset according to FIG. 3.

FIG. 5 is a schematic diagram of a three-segment headset capable of switching signal transmissions according to an embodiment of the present invention.

FIG. 6 is a signal transmission mode of the three-segment headset according to FIG. 5.

### DETAILED DESCRIPTION

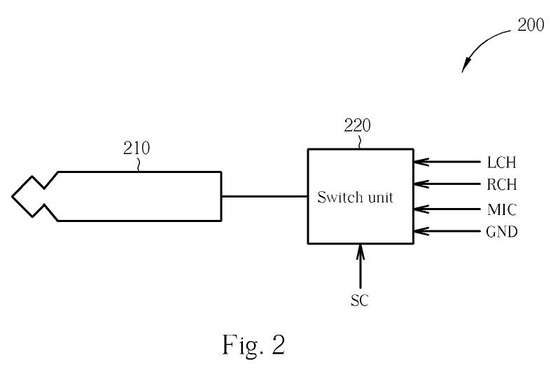

Please refer to FIG. 2, which is a schematic diagram of a headset device 200 capable of switching signal transmissions according to the present invention. The headset device 200 is capable of switching the signal transmissions of the headset device 200, and includes a headset plug 210 and a switch unit 220. The headset plug 210 is a four-segment plug or a three-segment plug, and includes a plurality of signal interfaces for transmitting a plurality of signals, such as a left-channel signal LCH, a right-channel signal RCH, a microphone signal MIC, and a grounding signal GND. The switch unit 220 is coupled to the headset plug 210 and is used for modifying an order in which the signal interfaces of the headset plug 210 transmit the plurality of signals according to a control signal SC.

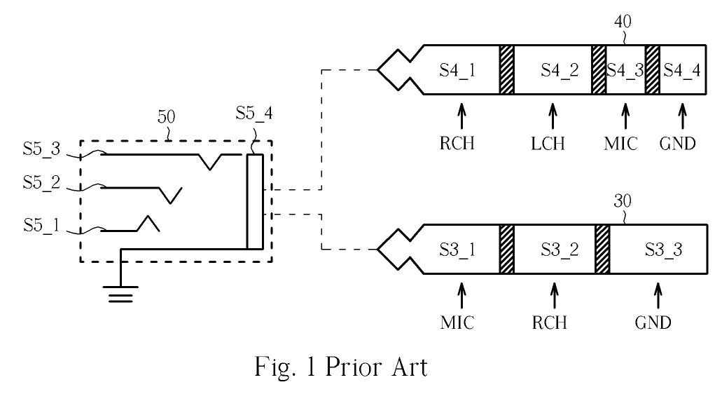

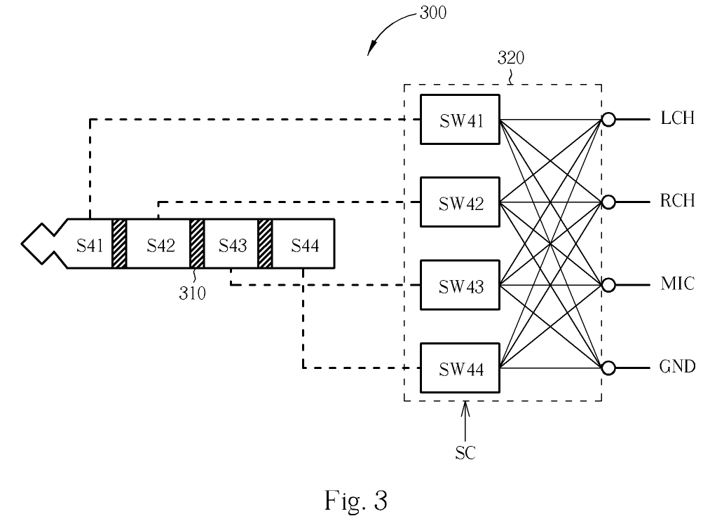

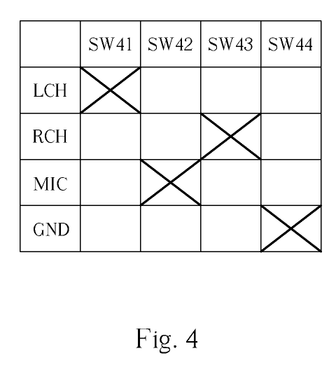

Take a four-segment headset for example. Please refer to FIG. 3, which is a partial schematic diagram of a four-segment headset 300 capable of switching signal transmissions according to an embodiment of the present invention. In the four-segment headset 300, a headset plug 310 is similar to the four-segment headset plug 40 shown in FIG. 1 and includes signal interfaces S41-S44. A switch unit 320 includes switches SW41-SW44, respectively coupled to the signal interfaces S41-S44. Each of the switches can only transmit one type of the signals, such as the left-channel signal LCH, the right-channel signal RCH, the microphone signal MIC, or the grounding signal GND. Moreover, each of the signals can be selected simultaneously by one of the switches SW41-SW44, which indicates that each signal corresponds to a signal interface. Thus, sixteen signal transmission modes can be obtained based on a relationship between the signal interfaces S41-S44 and the signals: the left-channel signal LCH, the right-channel signal RCH, the microphone signal MIC and the grounding signal GND. Under these circumstances, a user can generate the control signal SC via a control signal generator (i.e. a function key) for controlling the switches SW41-SW44 to switch between different signal transmission modes, so as to match signal allocation of the headset jack coupled to the headset plug 310. Please refer to FIG. 4, which depicts an instance of the sixteen signal transmission modes. According to the signal transmission mode shown in FIG. 4, the signal interfaces S41-S44 respectively transmit the left-channel signal LCH, the microphone signal MIC, the right-channel signal RCH, and the grounding signal GND.

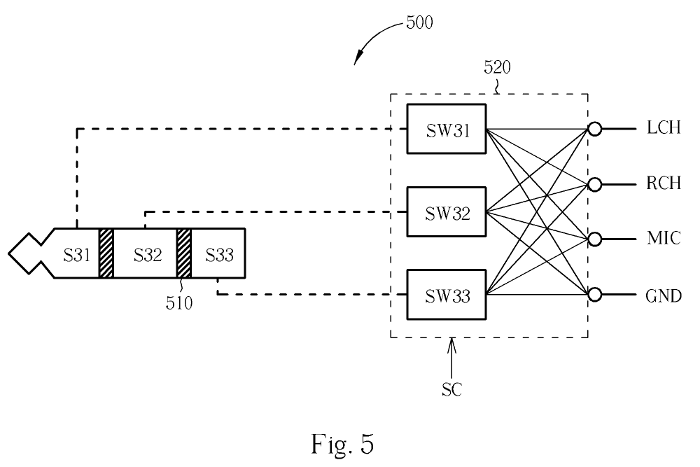

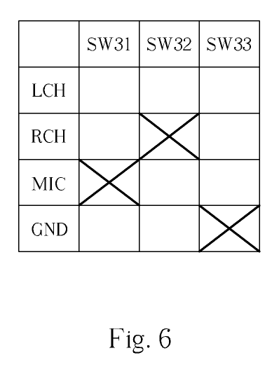

Therefore, the user can choose different signal transmission modes by controlling the switch unit 320 via the control signal SC, and the four-segment headset 300 is compatible with headset jacks with different signal allocations, increasing convenience to the user. In addition, a three-segment headset can be employed in the present invention. Please refer to FIG. 5, which is a partial schematic diagram of a three-segment headset 500 capable of switching signal transmissions according to an embodiment of the present invention. In the three-segment headset 500, a headset plug 510 is similar to the three-segment headset plug 30 shown in FIG. 1 and includes signal interfaces S31-S33. A switch unit 520 includes switches SW31-SW33, respectively coupled to the signal interfaces S31-S33. Similarly, the three-segment headset 500 can also switch between different signal transmission modes according to the control signal SC. Please refer to FIG. 6, which depicts an instance of the signal transmission modes. The manner used in the three-segment headset 500 to switch the signal transmission mode is quite alike to the manner used in the four-segment headset 300. The difference between the two is that the former can select either the left-channel signal LCH or the right-channel signal RCH for output, such that the number of signal transmission modes of the three-segment headset 500 is twelve combinations. Thus, similar to the four-segment headset 300, the three-segment headset 500 can also choose a compatible signal transmission mode by adjusting the control signal SC to control the switch unit 520.

Because the signal interface of a predefined last segment of both the three-segment headset plug and the four-segment headset plug is specified to transmit the grounding signal GND, the signal interface of the predefined last segment of the three-segment or four-segment headset jacks equipped on the electronic devices is also grounded for matching up the signal allocation of the headset plugs. Moreover, a reverse of the allocation of the left-channel signal LCH and the right-channel signal RCH may occur in the headset jacks compared with the headset plugs. In this situation, the user will not notice any difference when listening to sounds outputted in reverse from the speakers. However, regarding the microphone signal MIC, accurately matching of the signal allocation of the microphone signal MIC critically dominates functionality of transmitting and receiving the user's voice via the headset plug.

In order to simplify the number of times the switch unit switches to select compatible signal transmission modes, the signal transmission modes of the three-segment headset plug can be defined as the two following modes: (1) A first signal interface, a second signal interface, and a third signal interface used for transmitting an audio channel signal, the microphone signal, and the grounding signal, respectively; (2) The first signal interface, the second signal interface, and the third signal interface used for transmitting the microphone signal, the audio channel signal, and the grounding signal, respectively. As for the signal transmission modes of the four-segment headset plug, three modes can be employed as follows: (1) A first signal interface and a fourth signal interface are used for transmitting the microphone signal and the grounding signal, respectively, whereas a second signal interface and a third signal interface are used for transmitting the audio channel signal, respectively; (2) The second signal interface and the fourth signal interface are used for transmitting the microphone signal and the grounding signal, respectively, whereas the first signal interface and the third signal interface are used for transmitting the audio channel signal, respectively; (3) The third signal interface and the fourth signal interface are used for transmitting the microphone signal and the grounding signal, respectively, whereas the first signal interface and the second signal interface are used for transmitting the audio channel signal, respectively. The audio channel signal may be the left-channel signal LCH or the right-channel signal RCH. Therefore, using the signal transmission modes mentioned above reduces the number of switching times, so that the user can choose signal transmission modes compatible with the headset plug via the headset device of the present invention.

In summary, the present invention provides a headset device capable of switching signal transmissions of the headset device. The user can modify the order in which the signal interfaces transmits the corresponding signals according to the control signal, so as to select an appropriate signal transmission mode compatible with the signal allocation of the coupled headset jack. Therefore, the present invention provides four-segment and the three-segment headsets with adaptability to headset jacks of the electronic products with diverse signal allocation, increasing convenience to the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A headset device capable of switching signal transmissions comprising:
a headset plug comprising a plurality of signal interfaces for transmitting a plurality of signals; and
a switch unit coupled to the headset plug for modifying an order in which the plurality of signal interfaces transmits the plurality of signals according to a control signal.

2. The headset device of claim 1, wherein the plurality of signals comprises a left-channel signal, a right channel signal, a microphone signal and a grounding signal.

3. The headset device of claim 1, wherein the headset plug is a three-segment headset plug.

4. The headset device of claim 3, wherein the headset plug comprises a first-segment signal interface, a second-segment signal interface and a third-segment signal interface for transmitting an audio channel signal, a microphone signal, and a grounding signal, respectively.

5. The headset device of claim 4, wherein the audio channel signal is a left-channel signal or a right-channel signal.

6. The headset device of claim 3, wherein the headset plug comprises a first-segment signal interface, a second-segment signal interface and a third-segment signal interface for transmitting a microphone signal, an audio channel signal, and a grounding signal, respectively.

7. The headset device of claim 6, wherein the audio channel signal is a left-channel signal or a right-channel signal.

8. The headset device of claim 1, wherein the headset plug is a four-segment headset plug.

9. The headset device of claim 8, wherein the headset plug comprises a first-segment signal interface and a fourth-segment signal interface for transmitting a microphone signal and a grounding signal, and a second-segment signal interface and a third-segment signal interface for transmitting an audio channel signal.

10. The headset device of claim 9, wherein the audio channel signal comprises a left-channel signal and a right-channel signal.

11. The headset device of claim 8, wherein the headset plug comprises a second-segment signal interface and a fourth-segment signal interface for transmitting a microphone signal and a grounding signal, and a first-segment signal interface and a third-segment signal interface for transmitting an audio channel signal.

12. The headset device of claim 11, wherein the audio channel signal comprises a left-channel signal and a right-channel signal.

13. The headset device of claim 8, wherein the headset plug comprises a third-segment signal interface and a fourth-segment signal interface for transmitting a microphone signal and a grounding signal, and a first-segment signal interface and a second-segment signal interface for transmitting an audio channel signal.

14. The headset device of claim 13, wherein the audio channel signal comprises a left-channel signal and a right-channel signal.

15. The headset device of claim 1 further comprising a function key for generating the control signal.

16. A headset device capable of switching signal transmissions comprising:
a headset plug comprising at least three signal interfaces for transmitting an audio channel signal, a microphone signal and a grounding signal, respectively;
a function key for generating a control signal; and
a switch unit coupled to the headset plug for determining a signal transmission mode compatible with the headset plug according to the number of times of the received control signals.

17. The headset device of claim 16, wherein the audio channel signal comprises a left-channel signal and a right-channel signal.
